(19) United States
(12) Patent Application Publication
(10) Pub. No.: US 2003/0078892 A1
(43) Pub. Date: Apr. 24, 2003

(54) System, method and computer program product for a fail-safe start-up mechanism for clients of a license server

(76) Inventors: Daniel V. East, Phoenixville, PA (US); William J. Bentley, Elverson, PA (US)

Correspondence Address: VENABLE, BAETJER, HOWARD AND CIVILETTI, LLP, P.O. BOX 34385, WASHINGTON, DC, 20043-9998, US

(21) Appl. No.: 09/982,852

(22) Filed: Oct. 22, 2001

(51) Int. Cl. H04K 1/00; H04L 9/00; G06F 17/60

(52) U.S. Cl. 705/59

(57) ABSTRACT

A method, and corresponding system to implement the method, for managing access to concurrent software licenses at a licensee facility includes the steps of (i) determining whether a user has a valid software license to run a software application using a license management system (or a license server); and (ii) permitting a recognized user to run the software application (optionally with a punishment) if the license server is inaccessible. The permitting step can be performed only if the user has previously been authorized with a license management system. The punishment can be, for example, a time delay imposed between when the user attempts to run the software application and when the recognized user is permitted to run the software application. The time delay can be stored on a local workstation used by the user, as for example, an encrypted code key in a register of the local workstation. The punishment can be increased if the user subsequently attempts to run the application without authorization from the license server. The punishment can also be reduced if the user subsequently is validly authorized to run the software application using the license server. Other punishments such as impeding software operation, or limiting or modifying functionality of the software can be used.

### BACKGROUND OF THE INVENTION

1. Field of the Invention

The present invention relates generally to license servers and more particularly to providing client access to licensed software products using a license management system.

2. Related Art

Access and management of multiple copies of software is a continuing challenge to the software industry. It is in the interest of the software licensor to limit access to a software product commensurate to the extent and scope of a software license. For example, if the licensee of the software obtains a software license from the licensor to permit 25 users to concurrently access a particular software product, then it behooves the software licensor to disallow the use of the license by greater than 25 users at one time at the licensee site. Commonly available methods for controlling the use of the software include, e.g., hardware locks, disk serialization, disk-based copy protection and restrictive redistribution rights dictated by the terms of the site license.

Access and management of the software license is also desirable on the part of the licensee. Various conventional methods exist for management of access to software applications and the software license. In one scenario, access to the software license, via a key, for example, can be maintained and managed locally at each individual computer. In another scenario, access to the software license via a key can be maintained and managed at a license management system, one example is often referred to as a license server.

In either of the above scenarios, the client licensee can first obtain permission via an authorization or validation system to use the software application before software access is permitted. The permission can be provided, e.g., during installation or upon each use of the application. If the permission is obtained during installation, the licensee can be required to enter, e.g., a license key or serial number upon installation of the software product. Subsequent executions of the software product are freely permitted without license checks. The latter permission can sometimes be preferable in, e.g., consumer settings, where the software end-user is perhaps a home individual user, and software product profit margins from each end-user are small, and the likelihood of numerous individual or concurrent users is less likely. However, in commercial business settings, where many individuals (e.g., employees, consultants) may require access to the same application software, it can be preferable to require validation or authorization of a user each time that access to the software product is desired.

In the latter commercial business setting, use of a license management system can be preferred. Unfortunately, conventional systems and methods for accessing software using a license management system include no provision for granting access to software and the software license in the event of inaccessibility of the license management system.

### SUMMARY OF THE INVENTION

An exemplary embodiment of the present invention is directed to a system, method, and computer program product for providing access to application software in the event of inaccessibility of a license management system, including the steps of: determining whether a user has a valid software license to run a software application including sending a query to the license management system; and permitting a recognized user to execute said software application in the event of inaccessibility of the license management system.

In another exemplary embodiment of the present invention, the permitting step includes recognizing said user as a previously valid user, before permitting said recognized user to execute said software application.

In another exemplary embodiment of the present invention, the recognizing step includes determining if access to said software application by said user has previously been validly authorized via said license management system.

In another exemplary embodiment of the present invention, the method can further include executing said software application in a punishment mode including imposing a punishment.

In another exemplary embodiment of the present invention, the method can further include executing said software application in a punishment mode including imposing a punishment comprising a time delay.

In another exemplary embodiment of the present invention, the punishment mode can include imposing a punishment comprising a time delay is imposed between when said user attempts to run said software application and when said user is permitted to run said software application.

In another exemplary embodiment of the present invention, the punishment can include increasing said punishment upon occurrence of a first criterion.

In another exemplary embodiment of the present invention, the punishment can include decreasing said punishment upon occurrence of a second criterion.

In another exemplary embodiment of the present invention, the method can further include storing recognition of previously authorized access on a local workstation used by said recognized user.

In another exemplary embodiment of the present invention, the recognition can include storing an encrypted code key in a register of said local workstation.

In another exemplary embodiment of the present invention, the punishment mode can include increasing said punishment if said recognized user subsequently attempts to execute said application in failsafe mode in the event of inaccessibility of the license management system.

In another exemplary embodiment of the present invention, the punishment mode can include decreasing punishment if said recognized user subsequently attempts to execute said application including validated authorization by the license management system.

In another exemplary embodiment of the present invention, the punishment can include imposing at least one of a time delay, a time limit, a software impediment, and a disablement of functionality of said software application program.

In another exemplary embodiment of the present invention, the license management system can include a license server.

In another exemplary embodiment of the present invention, the permitting step can include determining whether any previously valid authorizations have been established with said license management system by checking a value set when said software application is initially validly installed.

Another exemplary embodiment of the present invention, sets forth a system, method and computer program product for managing access to concurrent software licenses, comprising: a network; a license management system coupled to said network operative to authorize a user of a software application; and a client workstation coupled to said network, wherein said client workstation comprises a validation device operative to permit a recognized user to execute said software application in the event of inaccessiblity of a license management system.

In another exemplary embodiment of the present invention, the validation device is operative to recognize whether said user previously obtained a valid authorization to execute said software application by said license management system before permitting execution of said software application.

In another exemplary embodiment of the present invention, the validation device permits said user to run said software application with a punishment.

In another exemplary embodiment of the present invention, the validation device permits said user to execute said software application with said punishment if a previously valid authorization of said user is recognized.

In another exemplary embodiment of the present invention, the license management system can include a license server.

In another exemplary embodiment of the present invention, the punishment can include a time delay, a time limit, a software impediment, or disablement of functionality of said software.

In another exemplary embodiment of the present invention, the punishment can increase if said user previously attempted access with said inaccessible license management system.

In another exemplary embodiment of the present invention, the punishment can decrease if said user subsequently is validly authorized using said license management system.

Yet another exemplary embodiment of the present invention sets forth a system, method and computer program product, the computer program product embodied on a computer readable medium, where the computer program product includes program logic including program code means for enabling a computer to determine whether a user has a valid software license to execute a software application including: program code means for enabling the computer to send a query to a license management system; and program code means for enabling the computer to permit recognized users to execute said software application in the event of inaccessibility of said license management system.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 illustrates an exemplary software licensee networked site environment, which is an exemplary environment wherein the software licensee can use the present invention;

FIG. 2 illustrates an exemplary operating environment for initializing the process of the present invention;

FIG. 3 illustrates an exemplary operative environment relating to step 206 of FIG. 2;

FIG. 4 illustrates an exemplary operative environment relating to step 208 of FIG. 2;

FIG. 5 illustrates an exemplary operative environment relating to step 404 of FIG. 4;

FIG. 6 illustrates an exemplary operative environment relating to step 406 of FIG. 4; and

FIG. 7 illustrates an exemplary operative environment relating to step 210 of FIG. 2.

### DETAILED DESCRIPTION OF AN EXEMPLARY EMBODIMENT OF THE PRESENT INVENTION

A preferred embodiment of the invention is discussed in detail below with reference to accompanying drawings. While specific implementations are discussed, it should be understood that this is done so for illustration purposes only. A person skilled in the relevant art will recognize that other components and configurations may be used without parting from the spirit and scope of the invention. In the drawings, like reference numbers generally indicate identical, functionally similar, and/or structurally similar elements. The drawing in which an element first appears is indicated by the leftmost digits in the corresponding reference number.

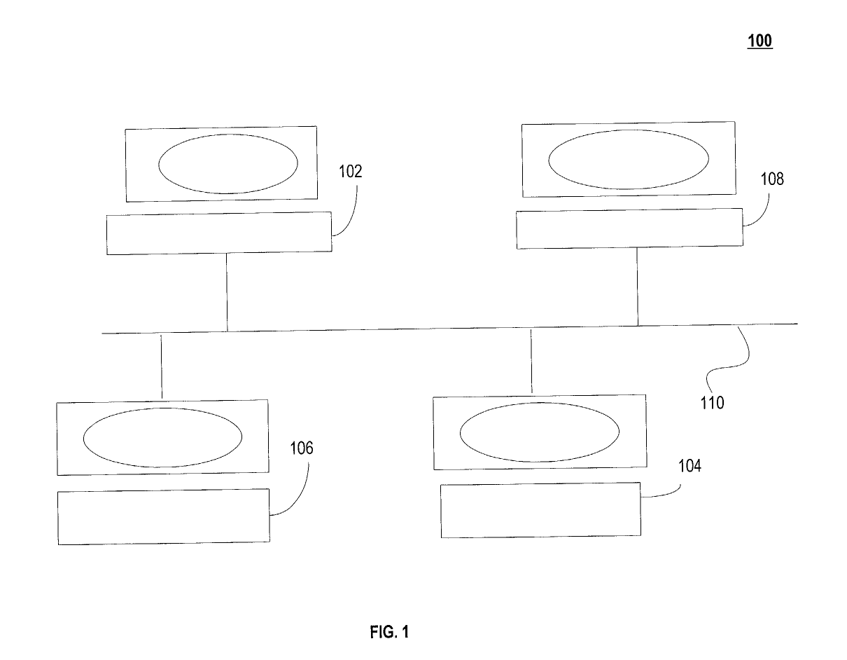

FIG. 1 illustrates an exemplary embodiment of a software licensee site environment 100, which is exemplary of the environment where a software licensee can use a software application product. The environment of FIG. 1 can include a computer network environment including a plurality of client workstations 102, 104, and 106 and server 108, interconnected by network 110.

Although the client workstations 102, 104, and 106 and server 108 are illustrated as conventional personal computers (PCs), it will be apparent to those skilled in the art that any foreseeable computing and/or communication devices can be used. Such devices can include, e.g., any conceivable wireline computing devices, wireless computing devices (including, for example, Web-enabled hand-held devices such as a Palm V™, Windows CE devices, pagers, “smart” phones using a wireless access protocol (WAP)), Internet appliances, and other computing and end user devices operating via satellite, infrared, radio frequency remote sensor or other means not requiring a physical connection or coupling to another computing device, appliance or network. The client workstations 102, 104, and 106 and server 108 are interconnected via an external wireline bus network 110, although as mentioned, these devices can be linked over any conceivable media and interface devices.

In an exemplary embodiment, each of client workstations 102, 104, and 106 and server 108 can include any or all of the following sub-components: one or more processors, an internal bus, a main memory (for example, a random access memory (RAM)), a secondary memory (for example, a disk, a storage device, and/or a removable storage device into which removable media can be placed including, e.g., a diskette, a compact diskette read only memory (CD ROM) or the like), a standard input device (for example, a mouse, or a keyboard), a standard output device (for example, a display, or a printer), and additional input/output (I/O) devices to the network 110 (for example, a network interface card (NIC) such as an Ethernet, Token Ring, or Asynchronous Transfer Mode (ATM)), a modem, or a wireless interface (for example, a wireless transceiver).

It will be apparent to those skilled in the relevant art that the above-described client workstations 102, 104, and 106, server 108, their accompanying sub-components, the communications media and interfaces used, as well as all other features of the environment of FIG. 1 have been provided as examples and are not intended to limit the breadth of the invention in any way.

Managing licensed software products used at the customer premises is an important and difficult task. Multiple copies of the software products must often be accessed and managed. This task is important both for the licensor and the licensee of the software. The software licensor desires limiting software usage to the extent and scope of the software license. For example, the software license may limit the number of concurrent users of the software product.

The licensor may grant the licensee a site license or other applicable license of its software product. For the present invention, the relative ownership interest or license interest of the parties is not relevant.

It can be important for the licensee (and not just the licensor) to control the access and management of the software. The licensee may be interested in determining the number of end-user desiring to concurrently use a particular software product, the amount frequency, and times of usage of a particular software product (for example, on a daily, monthly, yearly basis), the usage of a particular software product by a given user, or by a given client workstation.

For the purposes of the present invention, the software product itself can reside anywhere from which a user can obtain access. For example, a user using client workstation 102 can load and execute the software product locally, on the client workstation processor, or remotely, from or on for example server 108 or another remote processor. The remote processor can be located on a local or distant remote computing device (for example, a personal computer, mainframe, any intelligent peripheral device, or any conceivable device) coupled to the network 110 of client workstation 102 over any other network or combination of networks (for example, proprietary Intranets, the Internet, a virtual private network (VPN)) over any media (for example, wireline or wireless).

The software license can be managed using any of various methods. For example, the software license can be maintained and access to the software program can be managed locally by software at each client workstation 102, 104, and 106 when a user attempts to access and run the software product. Another method important for the present invention, maintains and manages access to the software application by software at a license management system. A license management system in an exemplary embodiment can execute on a server 108. Again, the remote processor of server 108 can be located on a local or distant remote computing device (for example, personal computer, mainframe, any intelligent peripheral device, or any conceivable device) connected to the network 110 of client workstation 102 over any network or combination of networks (for example, proprietary Intranets, the Internet, a virtual private network (VPN)) over any media (for example, wireline or wireless). In one exemplary embodiment described below, the license management system can execution the server 108 and can be referred to as a license server.

In commercial business settings where many users can require access to software concurrently, use of a license server can be useful. Users can include for example, company officers, employees, consultants, or even commercial and non-commercial sublicensees. In the commercial business setting, for users to access the software application, they can be required to validate authorization of a user each time the software product is executed. In a below-described exemplary embodiment, the commercial licensee can obtain a commercial site license, to obtain permission to access and execute the software product. If the licensee of the software obtains a site license from the licensor to permit 10 (ten) users to concurrently execute the software product, then the licensor would prefer to disallow the use of the license by greater than the licensed 10 concurrent users. In an exemplary embodiment, the licensee can be the owner or operator of the client work stations 102, 104, and 106 and the server 108 can be a license management system or license server communicating over network 110, enforcing the limit of 10 concurrent users.

Using a conventional license management system, in an exemplary embodiment, when a user attempts to run the software application on workstation 102, the workstation 102 checks with the license management system 108 to determine whether the number of concurrent software licenses has been exceeded. The license management system software can keep track of a count representing the number of concurrent users. When the user closes the application the software license can once again be made available for use by other users.

Unfortunately, from time to time, network 110 or license server 108 can exhibit a failure and can be rendered inaccessible by client workstations 102, 104 and 106. It is under these circumstances, i.e., inaccessibility of the license management system, that the present invention provides for application access and execution.

The present invention insightfully retains at client workstation 102 recognition of whether a user has previously been validly authenticated by a license management system. If the user is recognized by a validation module on a client workstation 102 as a recognized user, i.e., a previously valid user, then the recognized user can be permitted failsafe access to the software application and can execute the software application.

In an exemplary embodiment, the access and execution of the software application can be provided or permitted with a punishment such as, e.g., a time delay, a time limit, a software impediment (e.g., preventing printing), a loss or change of software functionality, or other performance degradation or penalty. The punishment can graduate or increase to greater levels in the event of recognition of multiple uses of the failsafe mode. Subsequently, if the user again accesses the software application using an authentication to the license server, then the level of punishment can be decreased.

For example, in an exemplary embodiment a punishment can be included with the permitted access to the software program such as, e.g., making the user pay a minor penalty by suffering a time delay between, e.g., when the user attempts to run the application and when the application is made available to the user. In an exemplary embodiment, the number of infractions can be cumulative so as to increase the punishment. The greater the number of failsafe accesses, the longer the delay time that the user can be made to suffer. In another exemplary embodiment, authorized valid access using the license server 108 on the part of the licensee can decrease the punishment. Here, the delay time can be reduced each time access is made via the license server 108, i.e., access using failsafe mode is not being misused. In one exemplary embodiment, the present invention permits recognized users previously authenticated access to access and execute the software application in failsafe mode in the event of, e.g., failure of the license management system of server 108. In yet another exemplary embodiment, failsafe mode overcomes the event of a connection failure between the license management system on server 108 and the client workstation 102 or failure of the license server 108 is given special treatment. These and other features of the present invention will be apparent to persons skilled in the relevant art in view of the following.

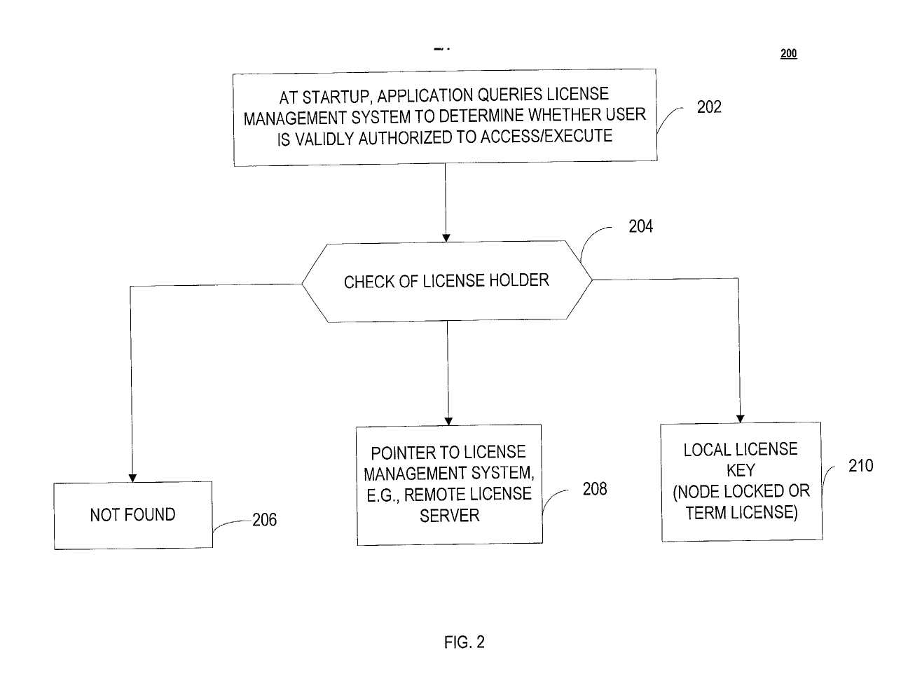

FIGS. 2-8 illustrate the operation of the present invention. Beginning with FIG.2, in step 202 of flow diagram 200 the user attempts to access and execute an application. For example, a user using client workstation 102 can attempt to run a software application such as, e.g., a computer aided design (CAD) program. In step 202, the application can submit a request or query to licensing management system software to enable operation of the software application. From step 202 flow diagram 200 can continue with step 204.

In step 204, a search can be made for a local license. If the licensing management system software resides on the client workstation 102, a local address can be searched for a local license, called a nodelocked license or term license.

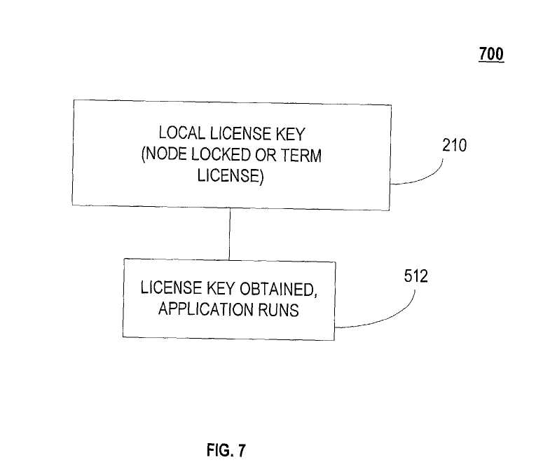

The determination of step 204 can determine which of three exemplary mutually exclusive conditions in steps 206, 208 or 210 can be performed. If a local license is indeed located on client workstation 102 then flow diagram 200 can continue with step 210, which can immediately continue FIG. 7. In FIG. 7, flow diagram 700 can proceed from step 210 to step 512 of FIG. 7. In step 2, the local licensing software (running on client workstation 102) can determine that the application can be permitted to run. The licensing software can then pass a key to a control program resident in the software application, permitting the software application to execute.

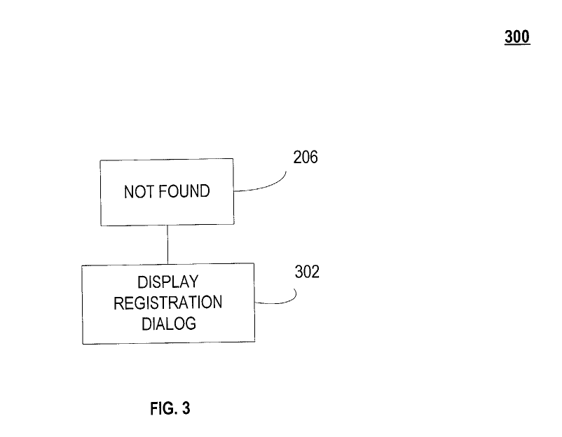

Step 206 is performed when it is determined in step 204 that no license is found. No license found means that the software product has not previously been validly authenticated. Control can be passed from 206 to step 302 of flow diagram 300 in FIG. 3. In step 302, where the user display can request that the user register the product. The user or system administrator can be required to obtain a valid license identification key from the licensor, and to enter the key locally on client workstation 102 (if the licensing software is locally resident) or to enter the key remotely, as for example on the server 108 (if the licensing software is remotely resident).

Step 208 is performed when it is determined that the local address searched for in step 204 contains a pointer to a remote device or a license management system (for example, server 108), instead of a local license. The pointer indicates that a connection must be established with the license management system, in order to determine whether the user will be permitted to use the software application. In an exemplary embodiment, the license management system can be a license server, i.e., server 108. The licensing software, as illustrated in flow diagram 400, could determine whether the license server is accessible to authorized access to and execution of the application residing on client workstation 102, to permit the application to run.

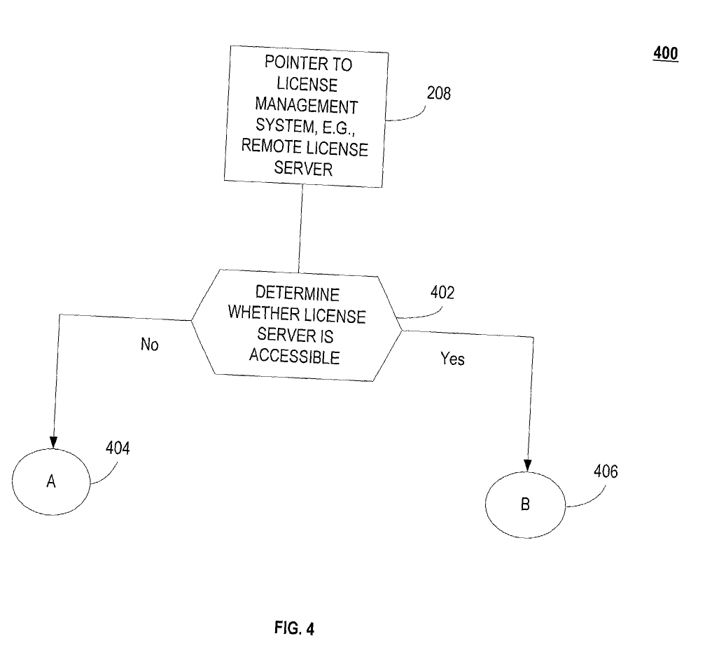

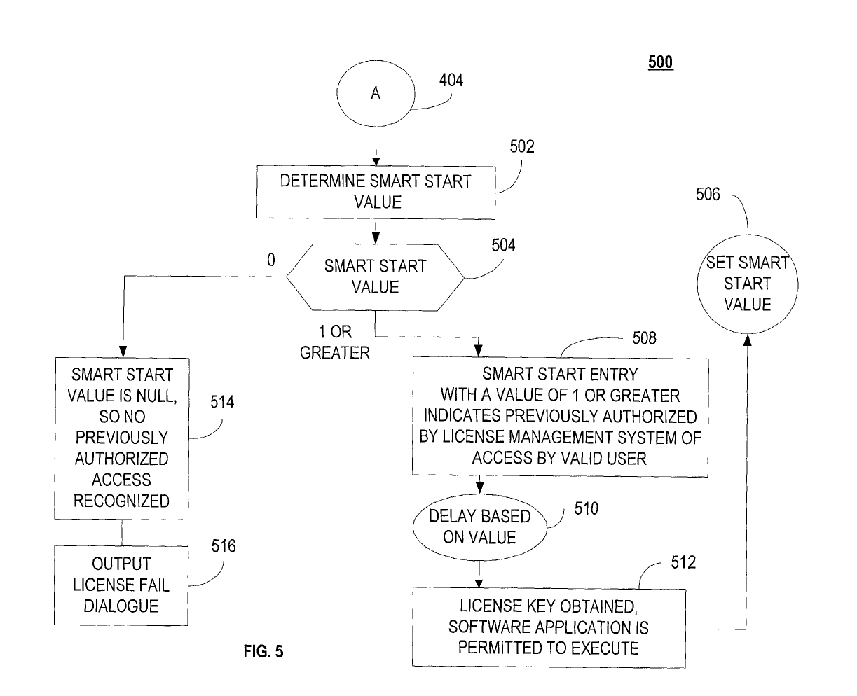

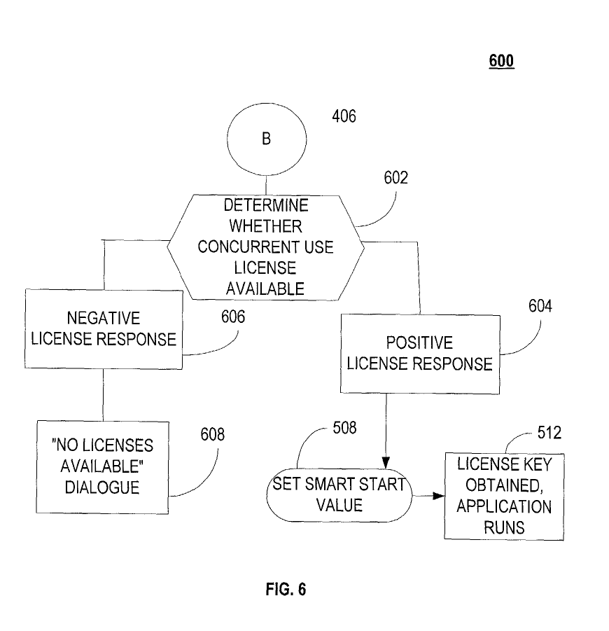

Specifically, referring to flow diagram 400 of FIG. 4, step 402 can determine whether the license server is accessible, by, e.g., attempting to establish a connection to server 108. If the attempt to connect to server 108 is unsuccessful because of, e.g., failure of the license server, network failure, or congestion, then control can pass to step 404 of FIG. 5. If the license server is determined to be accessible in step 402, then flow diagram 400 can continue with step 406, as illustrated in flow diagram 600 of FIG. 6.

Referring to FIG. 5, a SmartStart value can be checked in step 502 to determine whether the user is a recognized user, i.e., a user who has been previously authorized by the license management system as a valid user. In an exemplary embodiment, a null or zero value of the SmartStart value can indicate that the user was never previously authorized. A positive value can indicate previous authorization. The magnitude of the SmartStart value, in an exemplary embodiment, can identify frequency of access using failsafe mode, i.e., access when the license server is inaccessible. Prior to execution of step 502, in, e.g., step 506 the SmartStart value can be upon the initial registration (with a valid user key) and authorized access via the license management system and execution of the software application. Initially, the SmartStart value, in an exemplary embodiment, can be initialized to a null or zero value. In step 504, flow diagram 500 can branch depending on the value of the SmartStart value determined in step 502. The SmartStart value can be encoded or encrypted with an encryption key to prohibit being modified by the user at the licensee site in an exemplary embodiment. The SmartStart value can be stored in the registry of the local client workstation to allow for local recognition of previously authorized access by a valid user. Based on the value of the SmartStart value, control can pass to step 514 or step 508.

In step 514 it is determined that the SmartStart value is null indicating that the software application has never been successfully accessed previously by authorization of a license management system, so the user is presumed invalid. Therefore no failsafe operation of applications is allowed. Flow diagram 500 can continue with step 516, where a license fail dialog can be communicated to the user at client workstation 102.

On the other hand, if a positive SmartStart value is found, flow diagram 500 can continue with step 508. In this case, it was previously determined that the license server 108 is inaccessible, but authorized access to and execution of the software application was previously granted to the user. Under these circumstances, inaccessibility of the license server may be due to network traffic congestion, a break in the communication lines, or failure of the license server. From step 508, flow diagram 500 can continue with optional step 510. In step 510, in an exemplary embodiment, a punishment can be imposed on execution of the software application such as, e.g., impeding operation of the program in some way, modifying functionality of the software, adding a time delay before access, or a time limit. In step 506, the SmartStart value can be set to identify previously authorized access and also frequency of access using failsafe mode. In an exemplary embodiment, the magnitude of the SmartStart value can be used to track the number of times that a user has sought access or execution of the software application using failsafe mode, according to the present invention. The SmartStart value can be increased with each access under failsafe mode. The SmartStart value can be decreased with every authorized access using the license server. The level of punishment can vary based on the SmartStart value. In step 512, the application can be permitted to run, and a key can be passed to control program that can be resident in the software application, permitting the software application to execute.

In an exemplary embodiment, a time delay punishment system (which is explained in detail below) can be used. Here, the SmartStart value has previously been set to not only identify recognized previously authorized users, but also to provide a punishment commensurate to the magnitude of the value. Specifically, a delay time between when the user attempts to run the application and when the application is made available to the user. This delay time can be imposed in step 510. (The setting of the SmartStart value can occurs at initialization, or in step 506 as described with reference to FIG. 6.) Control can pass from step 510 to step 512, where the key can be passed to the control program resident in the software application, permitting the software application to run, but only after the punishment of the delay time is imposed.

Referring back to FIG. 4, if in step 402 it is determined that server 108 is accessible, and is successful, flow diagram 400 continues with step 406 of FIG. 6. The license server 108 can then perform other conventional functions of a license management system. For example, FIG. 6 illustrates an exemplary embodiment of a flow diagram 600. Flow diagram 600 can continue with step 602. In step 602 the license server 108 can check to determine whether any existing licenses are remaining for the software product. If licenses remain, then flow diagram 600 can continue with step 604. If no licenses remain, flow diagram 400 can continue with step 606.

Referring to FIG. 6, if a negative license response is received from license server 108, control can pass to step 606. The negative license response indicates that there are no available concurrent use licenses remaining for the user. Control can pass to step 608, where a license fail dialog can be communicated to the user at client workstation 102. Here, the user can be informed that that there is no license currently available, i.e., that the concurrent use license imit has been exceeded. Flow diagram 600 can immediately end following step 608 in an exemplary embodiment.

Referring back to FIG. 6, if a positive license response indicating available concurrent licenses is received in the determination step 602 from license server 108, then control can pass to step 604. Here, the positive license response indicates that there is an available concurrent use license remaining for the user. At this point if the SmartStart value is null, then the value can be changed to 1 to indicate that the user has been authorized by the license server. Subsequently, in step 512, the application can be permitted to run, and a license key can be passed to the control program resident in the software application, permitting the software application to run.

In step 506, the Smartstart value can be set to 1 from null in FIG. 6 when the user is first authorized, by the license management system or can have its value modified if an authorized access is subsequent to fail safe access. Recall that the SmartStart value can be used to assist in recognizing valid users that have been previously authorized by the license management system. The SmartStart value can also indicate the frequency or number of times that a user has used failsafe mode, (it can be used in the event of a punishment), according to the present invention, to access the software application when the license server is inaccessible. Further, subsequent authorized accesses validated by the license management system can be used to decrease any punishment in failsafe access.

The licensor can preset a delay period as desired. In one exemplary embodiment, the SmartStart value can be stored locally in a register of client workstation 102, and each time any user using client workstation 102 accesses the software application using license server authorization, the SmartStart value can be decremented to decrease the punishment that will be provided during failsafe operation. An exemplary punishment scheme can include imposing a 15 second delay punishment for each of the first four failsafe accesses, followed by one minute penalties for each additional subsequent authorized accesses can decrease the delay.

It will be apparent to those skilled in the relevant art that the present invention is not limited by the mechanics of how the SmartStart value is set. For example, it is possible to impose another type of punishment, to impose a time limit, a time delay that is calculated differently, to vary a delay by incrementing (instead of decrementing) the SmartStart value, or to store the SmartStart value remotely.

While various example embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for providing access to application software in the event of inaccessibility of a license management system, comprising the steps of:
determining whether a user has a valid software license to run a software application including sending a query to the license management system; and
permitting a recognized user to execute said software application in the event of inaccessibility of the license management system.

2. The method according to claim 1, wherein said permitting step comprises:
recognizing said user as a previously valid user, before permitting said recognized user to execute said software application.

3. The method according to claim 2, wherein said recognizing step comprises:
determining if access to said software application by said user has previously been validly authorized via said license management system.

4. The method according to claim 2, further comprising:
executing said software application in a punishment mode comprising:
imposing a punishment.

5. The method according to claim 2, further comprising:
executing said software application in a punishment mode comprises:
imposing a punishment comprising a time delay.

6. The method according to claim 5, wherein said punishment mode comprises:
imposing a punishment comprising a time delay is imposed between when said user attempts to run said software application and when said user is permitted to run said software application.

7. The method according to claim 4, wherein said punishment comprises:
increasing said punishment upon occurrence of a first criterion.

8. The method according to claim 4, wherein said punishment comprises:
decreasing said punishment upon occurrence of a second criterion.

9. The method according to claim 1, further comprising:
storing recognition of previously authorized access on a local workstation used by said recognized user.

10. The method according to claim 9, wherein said recognition is stored as an
encrypted code key in a register of said local workstation.

11. The method according to claim 4, wherein said punishment mode comprises:
increasing said punishment if said recognized user subsequently attempts to execute said application in failsafe mode in the event of inaccessibility of the license management system.

12. The method according to claim 4, wherein said punishment mode comprises:
decreasing punishment if said recognized user subsequently attempts to execute said application including validated authorization by the license management system.

13. The method according to claim 4, wherein said punishment comprises:
imposing at least one of a time delay, a time limit, a software impediment, and a disablement of functionality of said software application program.

14. The method according to claim 1, wherein said license management system is a license server.

15. The method according to claim 1, wherein said permitting step comprises
determining whether any previously valid authorizations have been established with said license management system by checking a value set when said software application is initially validly installed.

16. A system for managing access to concurrent software licenses, comprising:
a network;
a license management system coupled to said network operative to authorize a user of a software application; and
a client workstation coupled to said network,
wherein said client workstation comprises a validation device operative to permit a recognized user to execute said software application in the event of inaccessiblity of a license management system.

17. The system according to claim 16, wherein said validation device is operative to recognize whether said user previously obtained a valid authorization to execute said software application by said license management system before permitting execution of said software application.

18. The system according to claim 16, wherein said validation device permits said user to run said software application with a punishment.

19. The system according to claim 18, wherein said validation device permits said user to execute said software application with said punishment if a previously valid authorization of said user is recognized.

20. The system according to claim 19, wherein said license management system is a license server.

21. The system according to claim 19, wherein said punishment comprises at least one of a time delay, a time limit, a software impediment, and a disablement of functionality of said software.

22. The system according to claim 21, wherein said punishment increases if said user previously attempted access with said inaccessible license management system.

23. The system according to claim 22, wherein said punishment decreases if said user subsequently is validly authorized using said license management system.

24. A computer program product embodied on a computer readable medium, said computer program product comprising program logic comprising:
program code means for enabling a computer to determine whether a user has a valid software license to execute a software application including:
program code means for enabling the computer to send a query to a license management system; and
program code means for enabling the computer to permit recognized users to execute said software application in the event of inaccessibility of said license management system.
